(19) United States
(12) Patent Application Publication
(10) Pub. No.: US 2023/0376284 A1
(43) Pub. Date: Nov. 23, 2023

(54) USER INTERFACE HELP CONTENT DOCUMENT GENERATION

(71) Applicant: INTERNATIONAL BUSINESS MACHINES CORPORATION, ARMONK, NY (US)

(72) Inventors: Jin Shi, Ningbo (CN); Jie Jiang, Ningbo (CN); Ke Huan Yin, Ningbo (CN); Jing Lei Guo, Ningbo (CN); Wen Juan Nie, Ningbo (CN); Lu Fu, Ningbo (CN)

(21) Appl. No.: 17/664,431

(22) Filed: May 23, 2022

(51) Int. Cl. G06F 8/38; G06F 8/41; G06F 8/20; G06F 8/10

(52) U.S. Cl. CPC G06F 8/38; G06F 8/427; G06F 8/20; G06F 8/10; G06N 20/00

(57) ABSTRACT

A computer-implemented method, a computer system and a computer program product generate user interface (UI) help content. The method includes generating a descriptor file for a UI based on at least one of a design prototype and front-end code of the UI. The descriptor file describes a group of attributes related to help content for at least one UI element of the UI and includes attribute-value pairs for the at least one UI element of the UI. The method also includes transforming the descriptor file into a help content document for the UI using a trained natural language generation (NLG) model.

### BACKGROUND

The present disclosure relates generally to a user interface (UI) technique, and more specifically, to UI help content document generation.

In information technology, UI defines the way humans interact with machines. For example, a graphical user interface (GUI) allows a user to interact with an application or website using icons and other visual elements displayed on the GUI, which are typically referred to as UI elements, such as windows, check boxes, text fields, drop-down lists and the like. Knowing how to manipulate the UI elements enables the user to interact with the application or website faster and easier.

Typically, a user may refer to a UI help content document provided by an application or website before or during interaction with the application or website if he/she is not familiar with the UI. To this end, content providers may have to draft the UI help content document including detailed instructions on how to interact with each of the UI elements displayed on the UI manually, which requires significant time and effort. In view of this, how to generate the UI help content document in an efficient way is challenging to the content providers.

### SUMMARY

According to one embodiment of the present disclosure, there is provided a computer- implemented method for user interface (UI) help content generation. In this method, a descriptor file for a UI can be generated based on at least one of a design prototype and front-end code of the UI. The descriptor file describes a group of attributes related to help content for at least one UI element of the UI and includes attribute-value pairs for the at least one UI element of the UI. Also in this method, the descriptor file can be transformed into a help content document for the UI using a trained natural language generation (NLG) model.

In another embodiment of the present disclosure, the generating the descriptor file for the UI based on the at least one of the design prototype and the front-end code of the UI may include performing image recognition on the design prototype to recognize the at least one UI element and identify the group of attributes and corresponding values for the at least one UI element. In this embodiment, the generating the descriptor file may also include generating the descriptor file based on the identified group of attributes and the corresponding values for the at least one UI element.

In a further embodiment of the present disclosure, the generating the descriptor file for the UI based on the at least one of the design prototype and the front-end code of the UI may include performing code parsing on the front-end code to identify the at least one UI element and the group of attributes and corresponding values for the at least one UI element. In this embodiment, the generating the descriptor file for the UI may also include generating the descriptor file based on the identified group of attributes and the corresponding values for the at least one UI element.

In yet another embodiment of the present disclosure, the method may include updating the descriptor file by acquiring an attribute or a value manually input by a content provider.

In an additional embodiment of the present disclosure, the generating the descriptor file for the UI based on the at least one of the design prototype and the front-end code of the UI may include retrieving information from a database. The information may include an association of a UI element type to frequently used attributes of the UI element type.

In another embodiment of the present disclosure, the transforming the descriptor file into the help content document for the UI using the trained NLG model may include determining a language style to be used for help content of each UI element in the help content document of the UI. In this embodiment, the transforming the descriptor file into the help content document for the UI may also include generating help content of each UI element from the descriptor file based on an algorithm. The algorithm may be generated by training an NLG model with help content training documents of a determined language style for each UI element type and with corresponding training descriptor files.

In an embodiment of the present disclosure, the determined language style may be selected from a plurality of language styles.

In yet another embodiment of the present disclosure, the transforming the descriptor file into the help content document for the UI using the trained NLG model may include determining a plurality of language styles to be used for help content of each UI element in the help content document of the UI. In this embodiment, the transforming the descriptor file into the help content document for the UI may also include generating help content of each UI element from the descriptor file based on an algorithm selected from a plurality of algorithms, where each of the plurality of algorithms may correspond to each of the plurality of language styles and may be generated by training an NLG model with help content training documents of each of the plurality of language styles for each UI element type and with corresponding training descriptor files.

In a further embodiment of the present disclosure, the method may include training an NLG model with help content training documents of a language style for each UI element type and with corresponding training descriptor files to generate an algorithm for generating help content of each UI element from the descriptor file. In this embodiment, the training may include annotating a help content training document to generate annotations indicating mappings between expressions in help content of each UI element in the help content training document and values in attribute-value pairs of the UI element in a corresponding training descriptor file. The training may also include updating the annotations by acquiring corrections to at least one of: the annotations in the help content training document, the expressions of the help content training document, and attribute-value pairs of a training descriptor manually input by a content provider. In this embodiment, the method may also include training the NLG model based on updated annotations in the help content training document and attribute-value pairs in the corresponding training descriptor file.

According to another embodiment of the present disclosure, there is provided a computer system for UI help content generation. The computer system comprises one or more processors, one or more computer-readable memories, one or more computer-readable tangible storage media, and program instructions stored on at least one of the one or more tangible storage media for execution by at least one of the one or more processors via at least one of the one or more memories. The computer system is capable of performing a method where a descriptor file for a UI can be generated based on at least one of a design prototype and front-end code of the UI. The descriptor file describes a group of attributes related to help content for at least one UI element of the UI and includes attribute-value pairs for the at least one UI element of the UI. Also in this method, the descriptor file can be transformed into a help content document for the UI using a trained NLG model.

According to a yet another embodiment of the present disclosure, there is provided a computer program product for UI help content generation. The computer program product comprises a non-transitory computer readable storage medium within which program instructions are embodied. The program instructions are executable by a processor to cause the processor to perform a method where a descriptor file for a UI can be generated based on at least one of a design prototype and front-end code of the UI. The descriptor file describes a group of attributes related to help content for at least one UI element of the UI and includes attribute-value pairs for the at least one UI element of the UI. Also in this method, the descriptor file can be transformed into a help content document for the UI using a trained NLG model.

According to the computer-implemented method, computer system and computer program product for UI help content generation of the present disclosure, UI help content documents for UI elements of UIs can be generated in an automatic and efficient way. For example, with the improved user interface help content document generation approach of the present disclosure, the content providers do not have to draft the help content document manually, which reduces the time and effort spent by the content providers. In addition, when there is a change to the design prototype or front-end code of the UI, the descriptor file can be updated automatically, which will then be transformed to help content document to reflect the change in an efficient way and allows for easier maintenance of the UI help content document generation.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4 depicts an exemplary architecture for UI help content generation according to an embodiment of the present disclosure.

FIG. 5 depicts an example of a UI according to an embodiment of the present disclosure.

FIG. 6 depicts an example of a descriptor file generated for the UI as shown in FIG. 5.

FIG. 7 depicts another exemplary architecture for UI help content generation according to an embodiment of the present disclosure.

FIG. 8 depicts an exemplary architecture for help content transformer according to an embodiment of the present disclosure.

FIG. 9 depicts another exemplary architecture for help content transformer according to an embodiment of the present disclosure.

FIG. 10 depicts an exemplary schematic view of training the NLG model according to an embodiment of the present disclosure.

FIG. 11 shows a flowchart of a computer-implemented method 1100 of UI help content generation according to an embodiment of the present disclosure.

FIG. 12 shows a system 1200 of UI help content generation according to an embodiment of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

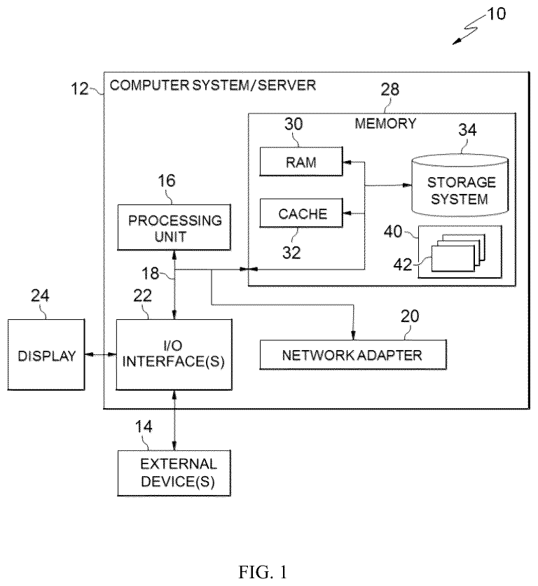

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processing units, e.g., processor 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

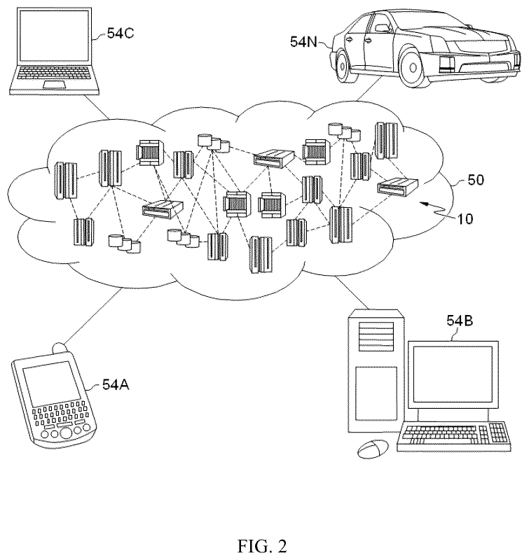

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

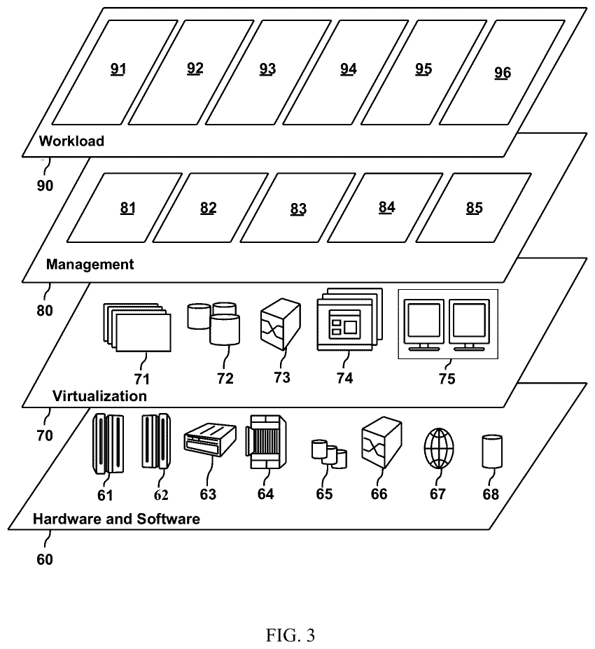

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and user interface (UI) help content generation 96.

As mentioned in the above, in order to help a user better understand various UI elements of a UI and therefore interact with the UI in an efficient way, content providers may have to draft a UI help content document including detailed instructions on how to interact with each of the UI elements displayed on the UI manually, which is low efficient and costly. Especially, as the number of UI elements of a UI or the number of UIs for which a UI help content document is required increases, it requires significant time and effort for the content providers to draft UI help content for each UI element of each UI manually.

In view of the above, there exists a need for an improved user interface help content document generation approach to generate UI help content documents for UI elements of UIs in an automatic and efficient way.

Embodiments of the present disclosure aim to solve at least one of the technical problems described above, and propose a method, system and computer program product for user interface help content generation based on a descriptor file for a UI. In the UI help content generation approach according to embodiments of the present disclosure, the descriptor file for a UI can be generated based on at least one of design prototype(s) and front-end code of the UI, and the descriptor file describes a group of attributes related to help content for at least one UI element of the UI and includes attribute-value pairs for the at least one UI element of the UI. In other words, the descriptor file describes a collection of attributes together with a value of each corresponding attribute for each UI element of the UI, and those attributes are related to help content. Accordingly, after the descriptor file is generated from at least one of design prototype(s) and front-end code, a trained natural language generation (NLG) model can be used to transform it into a help content document automatically. In such a way, the content providers do not have to draft the help content document manually, which reduces the time and effort spent by the content providers and thus accelerates the UI product to come into the market. In addition, when there is a change to the design prototype or front-end code of the UI, the descriptor file can be updated automatically, which will then be transformed to help content document to reflect the change in an efficient way and allows for easier maintenance of the UI help content document generation.

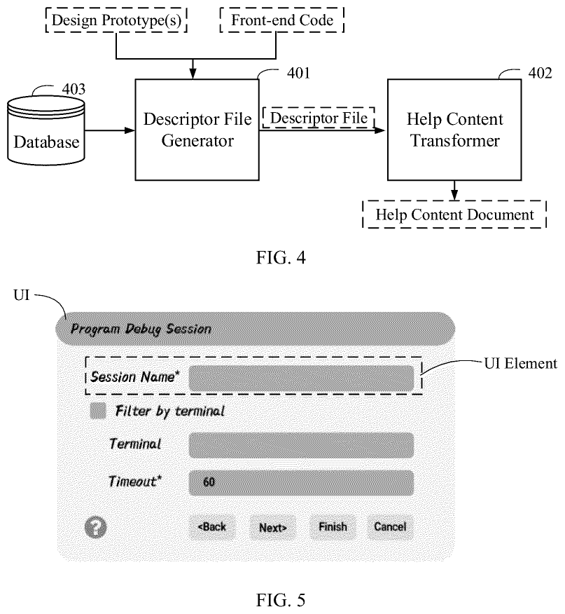

FIG. 4 depicts an exemplary architecture for UI help content generation according to an embodiment of the present disclosure. As shown in FIG. 4, the architecture includes a descriptor file generator 401, a help content transformer 402, and optionally, a database 403.

Descriptor file generator 401 is configured to generate a descriptor file for a UI based on at least one of design prototype(s) and front-end code of the UI. As mentioned above, the descriptor file describes a group of attributes related to help content for at least one UI element of the UI and includes attribute-value pairs for the at least one UI element of the UI. In an embodiment, descriptor file generator 401 is configured to generate the descriptor file based on either design prototype(s) of the UI or front-end code of the UI, or a combination thereof. Detailed descriptions of examples of the descriptor file will be described later with reference to FIG. 5 and FIG. 6.

FIG. 5 depicts an example of a UI according to an embodiment of the present disclosure. As shown in FIG. 5, the GUI with the title of “Program Debug Session” contains various types of UI elements, such as text fields “Session Name”, “Terminal” and “Timeout”; check box “Filter by terminal”; and buttons “Back”, “Next”, “Finish” and “Cancel”. In order to provide assistance to users in interacting with the UI, the help content document generated for the UI should provide information about how to interact with each UI element of the UI, for example, the help content document should be able to answer questions such as “What is this?”, “How could I use it?” and “What is the result?” for each UI element. Accordingly, when the number of UI elements of the UI is large, it requires significant time and effort for the content providers to draft UI help content for each UI element of each UI manually.

FIG. 6 depicts an example of a descriptor file generated for the UI as shown in FIG. 5. As mentioned above, a descriptor file is used to describe the UI from the perspective of help content and includes attribute-value pairs for each UI element of the UI. There can be various ways and formats to construct the descriptor file, for example, the descriptor file can be in any data-exchange format. In one example of the present disclosure, JSON is used as a data-exchange format for constructing the descriptor file, which is illustrated in FIG. 6.

As shown in FIG. 6, the descriptor file may consist of a list of entries, wherein each entry represents a corresponding UI element of the UI. For example, the entry as shown in the dashed box of FIG. 6 may correspond to the UI element “Session Name” of the text field type as shown in FIG. 5 and describes a group of attributes that describe the key information of that UI element from the perspective of help content. As shown in the dashed box of FIG. 6, the group of attributes may serve as the “skeleton” for each UI element of the UI, and each attribute is associated with a corresponding value to form multiple attribute-value pairs for the UI element, for example, the attribute “elementType” is associated with a value of “text field”, and so forth. It should be noted that although FIG. 6 only illustrates one entry of the descriptor file corresponding to one UI element, the descriptor file of the present disclosure may include other entries for other UI elements of the UI (for example, for UI elements of other UI element types) in a similar way. Obviously, the number and types of UI elements of the UI, the descriptor file constructed in the format of JSON, as well as the attributes and values for the UI element of the UI are just examples of the embodiments of the present disclosure, and do not limit the embodiments of the present disclosure to the above specific form of the above examples.

Referring back to FIG. 4, as mentioned above, descriptor file generator 401 is configured to generate the descriptor file based on at least one of design prototype(s) and front-end code of the UI. There can be various ways to generate the descriptor file based on at least one of design prototype(s) and front-end code, for example, via image recognition and/or code parsing.

In one embodiment, descriptor file generator 401 is configured to generate the descriptor file based on image recognition on the design prototype(s), for example, by utilizing an image analyzer that identifies key information related to help content from design prototype(s) based on image understanding, which is useful especially in case that the front-end code is not available for confidentiality and other reasons. For example, descriptor file generator 401 is configured to perform image recognition on the design prototype(s) to recognize at least one UI element and identify the group of attributes and corresponding values for the at least one UI element. Then, descriptor file generator 401 is configured to generate the descriptor file based on the identified group of attributes and corresponding values for the at least one UI element. In this example, if the descriptor file is generated from the design prototype(s), image recognition and analysis can be used to capture the UI elements in the design prototype(s) and identify the key information that is identifiable for each element as many as possible, including but not limited to:
Element type
Element label
Whether it's optional or required (Note: In some design, required fields are marked with an asterisk * and therefore can be recognized).
Default value if the default value is shown on the prototype(s)
. . .

Next, some attributes can be filled with values that are identifiable or recognizable from the prototype(s). As for attribute values that cannot be identified from the prototype(s), they can be left as empty. Accordingly, a descriptor file including attribute-value pairs for at least one UI element of the UI can be generated based on image recognition on the design prototype(s).

In another embodiment, descriptor file generator 401 is configured to generate the descriptor file based on code parsing on the front-end code of the UI, for example, by utilizing a code parser that inspects the front-end code of the UI, identifies key information related to help content and excludes irrelevant information based on programming language specifications or standards. For example, descriptor file generator 401 is configured to perform code parsing on the front-end code to identify at least one UI element and a group of attributes and corresponding values for the at least one UI element. Then, descriptor file generator 401 is configured to generate the descriptor file based on the identified group of attributes and corresponding values for the at least one UI element. In this example, if the descriptor file is generated from the front-end code, code parsing is used to identify the UI elements and the key information that is identifiable for each element as many as possible, including but not limited to:
Element type
Element label
Whether it's optional or required
Value range
Default value
List options
Action result
Element dependency
. . .

Next, similar to image recognition on the design prototype(s), some attributes can be filled with values that are identifiable from the front-end code. As for attribute values that cannot be identified from the front-end code, they can be left as empty. Accordingly, a descriptor file including attribute-value pairs for at least one UI element of the UI can be generated based on code parsing on the front-end code.

In yet another embodiment, descriptor file generator 401 is configured to generate the descriptor file based on both image recognition on the design prototype(s) and code parsing on the front-end code of the UI. For example, the results of the attribute-value pairs for at least one UI element of the UI generated from the design prototype(s) and the results of the attribute-value pairs for at least one UI element of the UI generated from the front-end code can be aggregated together, to account for one or more attribute and/or value that is wrongly identified or missed by one of the approaches, such that the image recognition and code parsing approaches are complementary and can be mutually verified. In this example, an accurate result of the attribute-value pairs for at least one UI element of the UI can be generated based on a combination of image recognition and code parsing approaches.

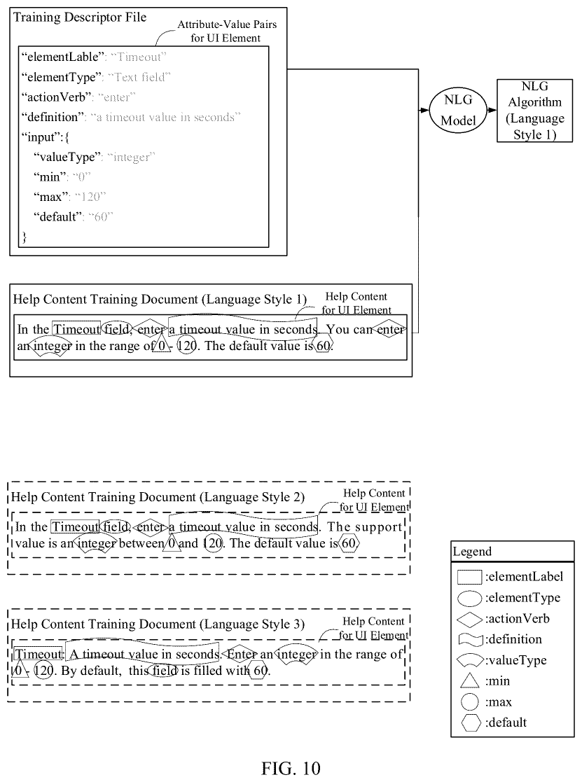

Help content transformer 402 is configured to transform the descriptor file into a help content document for the UI using a trained natural language generation (NLG) model. It can be understood that NLG uses artificial intelligence (AI) programming to produce written narratives by automatically transforming structured data into human-readable text using a trained model. In the present disclosure, rather than writing a help content document for the UI by a content provider, the help content document can be transformed from a previously extracted descriptor file which is in a structured data format listing attribute-value pairs for at least one UI element of the UI, such that the burdens related to writing the help content document manually can be relieved and the efficiency of generating the help content document can be increased. Detailed descriptions of examples of training the NLG model will be described later with reference to FIG. 10.

Database 403 is configured to store association information of UI element types with frequently used attributes thereof, which may be used to aid in generating of the descriptor file based on at least one of design prototype(s) and front-end code of the UI. For example, database 403 can be a relational database that associates each UI element type with frequently used attributes related to help content for that UI element type. Accordingly, the generating of the descriptor file for the UI based on at least one of design prototype(s) and front-end code of the UI is with the aid of association information of UI element types with frequently used attributes thereof retrieved from database 403. For example, the image analyzer that identifies key information related to help content from design prototype(s) based on image understanding and/or the code parser that inspects the front-end code of the UI to identify key information related to help content based on programming language specifications may identify the key information with the aid of the association information of UI element types with frequently used attributes thereof retrieved from database 403.

In this example, the association information may be established based on working experience of the content providers for a library of common UI element types and frequently used attributes of each UI element type. In the present disclosure, the reason to have such a database is that different element types are usually described in different aspects or with different focuses, so that the association information of UI element types with frequently used attributes thereof may be helpful in identifying the key information related to help content by the image analyzer and/or the code parser in an efficient way and thus is helpful in generating the descriptor file based on at least one of design prototype(s) and front-end code of the UI using the above mentioned image analyzer and/or code parser. For example, a text field is usually described based on attributes such as: i) “definition” attribute, which is associated with a value indicating what to specify in the field (or what the field is used for), ii) “inputType” attribute, which is associated with a value indicating the supported characters, such as alphanumeric; iii) “minlength” or “maxlength” attribute which is associated with a value indicating the minimum or maximum number of characters that can be filled in, and the like. In contrast, a drop-down list is usually described based on a different set of attributes such as: i) “listDefinition” attribute, which is associated with a value indicating what the list is used for, ii) “optionDefinition” attribute, which is associated with a value indicating what each list option means, and the like.

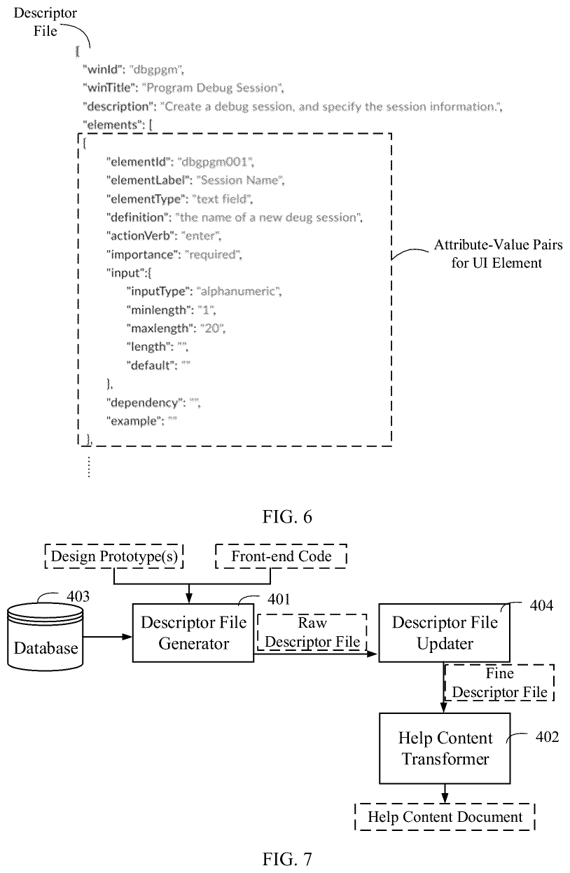

FIG. 7 depicts another exemplary architecture for UI help content generation according to an embodiment of the present disclosure. The architecture for UI help content generation as shown in FIG. 7 is similar to that shown in FIG. 4, except that the architecture for UI help content generation of FIG. 7 further includes a descriptor file updater 404 which is positioned between a descriptor file generator 401 and a help content transformer 402. Detailed descriptions of the components same as those shown in FIG. 4 will be omitted herein.

Descriptor file updater 404 is configured to update the descriptor file generated by descriptor file generator 401 by acquiring attribute(s) or value(s) manually input by a content provider. As shown in FIG. 7, the descriptor file generated by descriptor file generator 401 may be referred to as “raw descriptor file”, which is transferred to descriptor file updater 404. Then descriptor file updater 404 can acquire attribute(s) or value(s) manually input by a content provider, and updates the raw descriptor file accordingly, which may be referred to as “fine descriptor file” and is fed to help content transformer 402 for use in help content document generation. As mentioned above, it may be desired that the descriptor file generator 401 extracts attribute-value pairs of the UI elements of the UI as many as possible; however, there are still some attributes or values that cannot be recognized from the design prototype(s) or the front-end code of the UI. In this regard, descriptor file updater 404 allows for updates or amendments to the raw descriptor file to make it ready for help content transformation.

In an example, descriptor file updater 404 may acquire some attribute values related to real-world knowledge or other information that cannot be extracted from the design prototype(s) or the front-end code of the UI, and update the raw descriptor file generated by descriptor file generator 401 based on the attribute values. In this example, the attribute values that cannot be extracted from the design prototype(s) or the front-end code of the UI may include, for example, a value indicating “what a field is used for” regarding the “definition” attribute of a text field, a value indicating “what's the result of selecting a particular option” regarding the “optionDefinition” attribute of a drop-down list, and the like. For example, as shown in the descriptor file of FIG. 6, the value for the attribute “definition” is an example of attribute values that cannot be extracted from the design prototype(s) or the front-end code of the UI, and the value may be specified by the content provider and then updated into the raw descriptor file.

In another example, descriptor file updater 404 may acquire some new or custom attributes specified by the content provider to suit the requirements for help content generation. For example, a UI element may present different content to different user roles, and in such case, a content provider can add an attribute “role” to the UI element, and descriptor file updater 404 may update raw descriptor file generated by descriptor file generator 401 by adding the attribute “role” to the UI elements and the value thereof

It should be noted that descriptor file updater 404 can be implemented in various manners. For example, descriptor file updater 404 doesn't have to be notebook like, which renders descriptor files as text files, but it can be a GUI interface or chatbot that solicits inputs or answers and updates the raw descriptor file according to attribute(s) or value(s) manually input by the content provider.

Further, in practice for the UI design or development, content providers usually need to provide different types of help content for a same UI to suit different needs. For example, the types of help content documents may include but not limited to:
A tutorial document that provides task-like instructions telling users how to operate with the UI.
A reference document lists all the UI elements on the UI and provides description for each element.
Contextual help displayed on the UI to explain particular elements, e.g. hover text, tooltips, callouts, etc.

Although different types of help content documents describe the same material, they may use different language styles. As a result, content providers have to create and maintain different help content documents with different language styles. For example, when describing a text field named “Terminal”, different language styles can be used for the above different types of help content documents, which are listed as below:

TABLE 1
different language styles for different types of help content documents

| Document Type | Help Content |
|---|---|
| Tutorial document | In the Terminal field, specify the IP address or |
| | terminal address. |
| Reference document | Terminal |
| | Specifies the IP address or terminal address |
| Contextual help | The IP address or terminal address |

In addition, different organizations or even different product teams within the same organization may use different language styles. For example, they may use various ways to inform users that a text field is optional:
Optional: Specify the session timeout value in seconds in the Timeout field.
In the Timeout field, specify the session timeout value in seconds. This is an optional field.
(Optional) Session timeout value.

In order to keep the help content document in conformity with the language style conventions, the content providers have to get themselves very familiar with the language style guidelines/conventions of the UI products they work for. If the content providers work on different UI products with different language styles or work for different organizations, they need to take time to learn all those different language styles, which increases the burden of the content providers to draft the UI help content document.

In view of the above, there exists a need for a further improved user interface (UI) help content document generation approach to generate UI help content documents of different language styles in an automatic and efficient way. Accordingly, in the present disclosure, for each language style, an NLG model is trained to generate an NLG algorithm for each element type, such that the UI help content document of the desired language style can be generated by using a corresponding NLG algorithm. With the NLG algorithm generated for each element type in each language style, content providers no longer need to investigate the language style guidelines since the NLG model will learn different language styles for each UI element type and generate the NLG algorithms to process more document descriptors extracted from at least one of design prototype(s) and front-end code of more UIs and transform them into help content documents easily. Moreover, non-professional content providers (e.g., UX designers and developers) can create help content document with the aid of the NLG model at reduced time and effort.

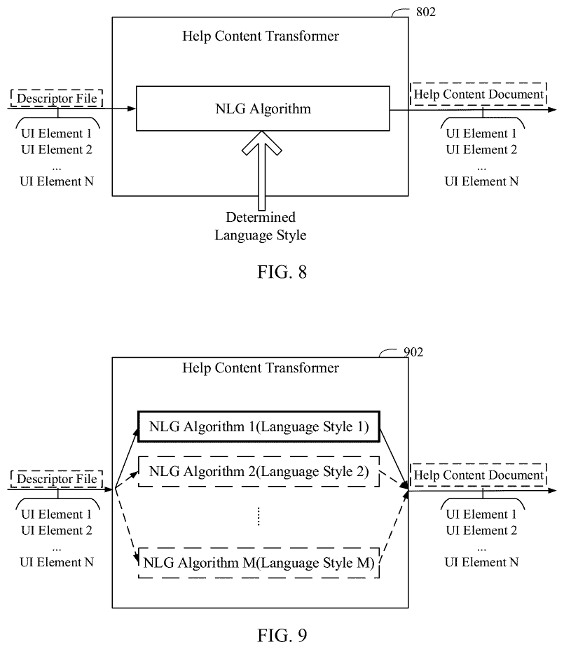

FIG. 8 depicts an exemplary architecture for help content transformer according to an embodiment of the present disclosure. It should be noted that help content transformer 802 as shown in FIG. 8 may correspond to help content transformer 402 described with respect to FIG. 4 and FIG. 7.

Help content transformer 802 is configured to determine a language style to be used for help content of each UI element in the help content document of the UI. Then, help content transformer 802 is configured to generate help content of each UI element from the descriptor file based on an algorithm, wherein the algorithm is generated by training an NLG model with help content training documents of the determined language style for each UI element type and with corresponding training descriptor files.

As shown in FIG. 8, in this example, the determined language style can be selected from a plurality of language styles and used by the help content transformer 802, such that help content transformer 802 may generate help content of each UI element from the descriptor file based on an NLG algorithm corresponding to the determined language style. In this example, all the UI elements (e.g., UI element 1 through N) of the UI may be of a same language style. An NLG algorithm trained with help content training documents of that language style and with corresponding training descriptor files can be used for generating help content of each UI element of the UI. For example, for a UI element of text field type, the NLG model can be trained with help content training documents including help content of multiple UI elements of text field type in the determined language style and with corresponding training descriptor files, such that a language construction algorithm for text field UI element type can be generated for the determined language style. Similarly, for a UI element of drop-down list type, the NLG model can be trained with help content training documents including help content of multiple UI elements of drop-down list type in the determined language style and with corresponding training descriptor files, such that a language construction algorithm for drop-down list UI element type can be generated for the determined language style. In this manner, the NLG algorithm corresponding to the determined language style may contain multiple language construction algorithms associated with different UI element types, such that help content transformer 802 can generate help content of each UI element from the descriptor file using the NLG algorithm.

FIG. 9 depicts another exemplary architecture for help content transformer according to an embodiment of the present disclosure. It should be noted that help content transformer 902 as shown in FIG. 9 may also correspond to help content transformer 402 described with respect to FIG. 4 and FIG. 7.

Help content transformer 902 is configured to determine a plurality of language styles to be used for help content of each UI element in the help content document of the UI. Then, help content transformer 902 is configured to generate help content of each UI element from the descriptor file based on an algorithm selected from a plurality of algorithms, wherein each of the plurality of algorithms is corresponding to each of the plurality of language styles and is generated by training an NLG model with help content training documents of each of the plurality of language styles for each UI element type and with corresponding training descriptor files.

As shown in FIG. 9, in this example, instead of maintaining one algorithm for a same UI element type in a same language style, multiple algorithms can be generated for the same UI element type with different language styles to allow for language variety for the UI help content generation. It may be beneficial to have some language variety in the UI help content document to make the language sound less robotic, for example for a chatbot. In this example, multiple algorithms can be kept for the same UI element type with different language styles, and a suitable mechanism such as a mechanism of random selection can be used to rotate the algorithms when generating content for the same UI element type. For example, a first algorithm for generating help content of UI element of text field type in a first language style can be used for generating the help content of UI elements of text field type in a help content document, whereas a second algorithm for generating help content of UI element of text field type in a second language style can be used for generating the help content of UI elements of text field type in another help content document, which allows for language variety for UI help content generation and makes the language of the UI help content documents sound less robotic.

FIG. 10 depicts an exemplary schematic view of training the NLG model according to an embodiment of the present disclosure.

In the present disclosure, an NLG model can be trained with help content training documents of a language style for each UI element type and with corresponding training descriptor files to generate an algorithm for generating help content of each UI element from the descriptor file. In an embodiment, the training may comprise the following steps. Firstly, a help content training document can be annotated to generate annotations indicating mappings between expressions in help content of each UI element in the help content training document and values in the attribute-value pairs of the UI element in a corresponding training descriptor file. Then, the annotations can be updated by acquiring corrections to at least one of the annotations in the help content training document, the expressions of the help content training document and the attribute-values pairs of the training descriptor manually input by a content provider. Finally, the NLG model can be trained based on the updated annotations in the help content training document and the attribute-value pairs in the corresponding training descriptor file.

In the following, the process for training the NLG model will be described with reference to the UI element type of text field for different language styles, however, it should be noted that the training can be done in a similar manner for other UI element types. In this example, for the UI element type of text field, the training samples can be formed from one or more help content training documents of each language style and corresponding one or more training descriptor files. Please be noted that the help content training documents and the training descriptor files can be generated during the designing or development of prior Uls, and they have the same formats as the help content documents and the descriptor files as mentioned above, respectively. In this example, the training samples can be formed by selecting help content of multiple UI elements of text field type from the one or more help content documents in the determined language style and corresponding attribute-value pairs of the multiple UI elements of text field type from the corresponding one or more descriptor files, such that the NLG model can be trained to obtain a language construction algorithm for each UI element type in each language style.

For example, as shown in FIG. 10, for the UI element type of text field, one or more help content training documents of language style 1 and corresponding one or more training descriptor files can be input into the NLG model for training to generate an NLG algorithm for language style 1. Subsequently, the NLG algorithm can be used for generating help content of UI elements of text field type in language style 1 based on respective descriptor files for future developed UIs. In addition, the help content for the UI elements of the help content training documents can be annotated to generate annotations indicating mappings between the expressions in the help content training documents and values in the attribute-value pairs of the UI elements in corresponding training descriptor files, such that the annotated help content training documents together with the corresponding training descriptor files are ready to be fed to the NLG model for training based on the mappings from the annotated training samples.

It should be noted that FIG. 10 illustrates only one help content training document and its corresponding training descriptor for one UI element for the purposes of simplicity, but the number of the training documents and the training descriptors can be numerous according to the desired accuracy of the generated algorithm.

In embodiments of the present disclosure, the NLG model may be trained in an iterative manner such that the NLG algorithm can be refined continually. For example, initially, the NLG model may be trained based on a set of help content training documents and corresponding training descriptor files such that the NLG model will be able to generate annotations for a different set of help content training documents. Next, the different set of help content training documents and corresponding training descriptors can be used to refine the NLG model with the aid of corrections manually input by the content provider to the annotations. Specifically, the initially trained NLG model may generate one or more annotations in a help content training document, for which over-annotation or miss-annotation may occur. Then, corrections may be made to the generated annotations in the help content training document, the expressions of the help content training document and/or the attribute-values pairs of the training descriptor, which in turn lead to updates to the annotations in the help content training document. Based on the updates to the annotations in the help content training document due to the corrections manually input by the content provider, the NLG model can learn from the corrected mappings between the expressions in the help content training document and values in the attribute-value pairs of corresponding training descriptor file and can be refined to generate an accurate NLG algorithm.

For example, the UI element as shown in the help content training document of language styles 1 through 3 of FIG. 10 may correspond to the UI element “Timeout” as shown in FIG. 5, and the help content for the UI element can be annotated by the initially trained NLG model to generate annotations indicating mappings between the expressions in the help content training document and values in the attribute-value pairs of the UI element in a corresponding training descriptor file, for example, the expressions of “Timeout”, “enter”, “a timeout value in seconds”, “integer”, “0”, “120” and “60” can be annotated by the initially trained NLG model.

In addition, as mentioned above, in order to make the mapping between the values in the attribute-value pairs and expressions of the help content more accurate such that the NLG model can be refined, the annotations can be updated by acquiring corrections to the annotations generated by the NLG model, the expressions of the help content training document and/or the attribute-values pairs of the training descriptor manually input by a content provider, such that corrected annotations for the training samples can be fed to the NLG model to provide an accurate algorithm for generating help content of each UI element from the descriptor file.

In an example, the corrections manually input by a content provider may be performed to compensate for the annotations that are missed. For example, still referring to FIG. 10, as for the attribute of elementType for the UI element of “Timeout”, the expression “field” in the help content of the help content training document was originally not annotated because there is no such attribute value as “field” in the descriptor file but only “text field”. In such a case, the training descriptor file can be updated by changing the “text field” attribute into “field” based on corrections manually input by a user, which leads to updates to the annotations as shown in FIG. 10. As another example, similarly, the help content training document can also be updated by changing the expression “Timeout field” into “Timeout text field”. In both cases, the expression related to the value of the elementType can then be identified and annotated in the help content training document. Accordingly, the annotations can be updated by updating the content of the help content training document and/or the training descriptor, for example, by updating the expressions of the help content of the help content training document and/or the attributes or values for the attribute-values pairs of the training descriptor.

In another example, the corrections manually input by a content provider may be performed to reduce over-annotation where some expressions of the help content are annotated but should not. In an example, the numerical value “120” may appear in the help content several times. One of them corresponds to the max value for the “Timeout” text field but others do not. However, some of them may be wrongly annotated as the value of the attribute “max” of the “Timeout” text field, which can be referred to as over-annotation. In such a case, the corrections manually input by a content provider may be made to correct the wrong annotations, such that the annotations of the help content training document can be updated and thus the wrong annotations can be avoided in future help content training documents. Accordingly, the NLG model may learn from this correction and can be further trained based on the updated annotations.

Accordingly, with the annotated help content training documents and corresponding training descriptor files, the NLG model can be trained to generate a language construction algorithm for each UI element type in each language style, for example, based on the updated annotations in the help content training documents and the attribute-value pairs in the corresponding training descriptor files. As shown in FIG. 10, for the UI element type of text field in language style 1, the language construction algorithm can be “In the (elementLabel) (elementType), (actionVerb) { article } (definition). You can (actionVerb) { article} (valueType) in the range of (min)-(max). The default value is (default)”.

Similarly, for the UI element type of text field in language style 2, another language construction algorithm can be generated based on the annotated help content documents in language style 2 and it can be “ In the (elementLabel) (elementType), (actionVerb) {article} (definition). The support value is {article} (valueType) between (min) and (max). The default value is (default)” . The help content training documents in language style 3 can also be annotated and used for training.

It should be noted that the above language construction algorithms for the UI element of text field type are provided as examples only, and do not limit the embodiments of the present disclosure to the above specific form of the algorithms.

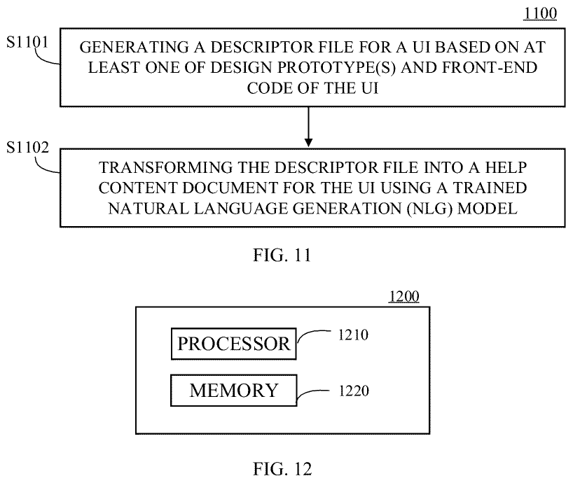

FIG. 11 shows a flowchart of a computer-implemented method 1100 of UI help content generation according to an embodiment of the present disclosure. The detailed description of method 1100 can refer to the content described in the above with respect to FIGS. 1-10. For example, method 1100 can be executed by the architecture for UI help content generation described with respect to FIG. 4 and FIG. 7. Each step of method 1100 can be performed by one or more processing units, such as central processing unit (CPU).

With reference to FIG. 11, method 1100 comprises steps 1101-1102. At step 1101, a descriptor file for a UI can be generated based on at least one of design prototype(s) and front-end code of the UI. The descriptor file describes a group of attributes related to help content for at least one UI element of the UI and includes attribute-value pairs for the at least one UI element of the UI.

In one example, generating a descriptor file for a UI based on at least one of design prototype(s) and front-end code of the UI can comprise: performing image recognition on the design prototype(s) to recognize the at least one UI element and identify the group of attributes and corresponding values for the at least one UI element; and generating the descriptor file based on the identified group of attributes and corresponding values for the at least one UI element.

In another example, generating a descriptor file for a UI based on at least one of design prototype(s) and front-end code of the UI can comprise: performing code parsing on the front-end code to identify the at least one UI element and the group of attributes and corresponding values for the at least one UI element; and generating the descriptor file based on the identified group of attributes and corresponding values for the at least one UI element.

In yet another example, the generating a descriptor file for a UI based on at least one of design prototype(s) and front-end code of the UI can be with the aid of association information of UI element types with frequently used attributes thereof retrieved from a database.

Optionally the method 1100 can also comprise a step of updating the descriptor file by acquiring attribute(s) or value(s) manually input by a content provider.

At step 1102, the descriptor file can be transformed into a help content document for the UI using a trained natural language generation (NLG) model.

In one example, the transforming the descriptor file into a help content document for the UI using an NLG model can comprise: determining a language style to be used for help content of each UI element in the help content document of the UI; and generating help content of each UI element from the descriptor file based on an algorithm, wherein the algorithm is generated by training an NLG model with help content training documents of the determined language style for each UI element type and with corresponding training descriptor files. In this example, the determined language style is selected from a plurality of language styles.

In another example, the transforming the descriptor file into a help content document for the UI using an NLG model can comprises: determining a plurality of language styles to be used for help content of each UI element in the help content document of the UI; and generating help content of each UI element from the descriptor file based on an algorithm selected from a plurality of algorithms, wherein each of the plurality of algorithms is corresponding to each of the plurality of language styles and is generated by training an NLG model with help content training documents of each of the plurality of language styles for each UI element type and with corresponding training descriptor files.

Optionally, the method 1100 can also comprise a step of training an NLG model with help content training documents of a language style for each UI element type and with corresponding training descriptor files to generate an algorithm for generating help content of each UI element from the descriptor file. In this example, the training can comprises: annotating a help content training document to generate annotations indicating mappings between expressions in help content of each UI element in the help content training document and values in the attribute-value pairs of the UI element in a corresponding training descriptor file; updating the annotations by acquiring corrections to at least one of the annotations in the help content training document, the expressions of the help content training document and the attribute-values pairs of the training descriptor manually input by a content provider; and training the NLG model based on the updated annotations in the help content training document and the attribute-value pairs in the corresponding training descriptor file.

FIG. 12 shows a system 1200 of UI help content generation according to an embodiment of the present disclosure. The system 1200 of UI help content generation comprises one or more processors 1210 and a memory 1220 coupled to at least one of the processors 1210. A set of computer program instructions are stored in the memory 1220. When executed by at least one of the processors 1210, the set of computer program instructions perform following series of actions. A descriptor file for a UI can be generated based on at least one of design prototype(s) and front-end code of the UI. The descriptor file describes a group of attributes related to help content for at least one UI element of the UI and includes attribute-value pairs for the at least one UI element of the UI. The descriptor file can be transformed into a help content document for the UI using a trained NLG model.

In an embodiment, the generating a descriptor file for a UI based on at least one of design prototype(s) and front-end code of the UI can comprise: performing image recognition on the design prototype(s) to recognize the at least one UI element and identify the group of attributes and corresponding values for the at least one UI element; and generating the descriptor file based on the identified group of attributes and corresponding values for the at least one UI element.

In an embodiment, the generating a descriptor file for a UI based on at least one of design prototype(s) and front-end code of the UI can comprise: performing code parsing on the front-end code to identify the at least one UI element and the group of attributes and corresponding values for the at least one UI element; and generating the descriptor file based on the identified group of attributes and corresponding values for the at least one UI element.

In an embodiment, the set of computer program instructions can further perform an action of updating the descriptor file by acquiring attribute(s) or value(s) manually input by a content provider.

In an embodiment, the generating a descriptor file for a UI based on at least one of design prototype(s) and front-end code of the UI is with the aid of association information of UI element types with frequently used attributes thereof retrieved from a database.

In an embodiment, the transforming the descriptor file into a help content document for the UI using an NLG model can comprise: determining a language style to be used for help content of each UI element in the help content document of the UI; and generating help content of each UI element from the descriptor file based on an algorithm, wherein the algorithm is generated by training an NLG model with help content training documents of the determined language style for each UI element type and with corresponding training descriptor files. In this embodiment, the determined language style is selected from a plurality of language styles.

In an embodiment, the transforming the descriptor file into a help content document for the UI using an NLG model can comprise: determining a plurality of language styles to be used for help content of each UI element in the help content document of the UI; and generating help content of each UI element from the descriptor file based on an algorithm selected from a plurality of algorithms, wherein each of the plurality of algorithms is corresponding to each of the plurality of language styles and is generated by training an NLG model with help content training documents of each of the plurality of language styles for each UI element type and with corresponding training descriptor files.

In an embodiment, the set of computer program instructions can further perform an action of training an NLG model with help content training documents of a language style for each UI element type and with corresponding training descriptor files to generate an algorithm for generating help content of each UI element from the descriptor file. In this embodiment, the training can comprise: annotating a help content training document to generate annotations indicating mappings between expressions in help content of each UI element in the help content training document and values in the attribute-value pairs of the UI element in a corresponding training descriptor file; updating the annotations by acquiring corrections to at least one of the annotations in the help content training document, the expressions of the help content training document and the attribute-values pairs of the training descriptor manually input by a content provider; and training the NLG model based on the updated annotations in the help content training document and the attribute-value pairs in the corresponding training descriptor file.

The descriptions above related to the process of method 1100 can also be applied to system 1200, and details are omitted herein for conciseness.

In addition, according to another embodiment of the present disclosure, a computer program product for UI help content generation is disclosed. As an example, the computer program product comprises a non-transitory computer readable storage medium having program instructions embodied therewith, and the program instructions are executable by a processor. When executed, the program instructions cause the processor to perform one or more of the above described procedures, and details are omitted herein for conciseness.

It should be noted that the processing of the method of UI help content generation or achieved by the system of UI help content generation as described hereinbefore according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand- alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for user interface (UI) help content generation, comprising:
generating, by one or more processing units, a descriptor file for a UI based on at least one of a design prototype and front-end code of the UI, wherein the descriptor file describes a group of attributes related to help content for at least one UI element of the UI and includes attribute-value pairs for the at least one UI element of the UI; and
transforming, by the one or more processing units, the descriptor file into a help content document for the UI using a trained natural language generation (NLG) model.

2. The computer-implemented method of claim 1, wherein the generating, by the one or more processing units, the descriptor file for the UI based on the at least one of the design prototype and the front-end code of the UI comprises:
performing, by the one or more processing units, image recognition on the design prototype to recognize the at least one UI element and identify the group of attributes and corresponding values for the at least one UI element; and
generating, by the one or more processing units, the descriptor file based on the identified group of attributes and the corresponding values for the at least one UI element.

3. The computer-implemented method of claim 1, wherein the generating, by the one or more processing units, the descriptor file for the UI based on the at least one of the design prototype and the front-end code of the UI comprises:
performing, by the one or more processing units, code parsing on the front-end code to identify the at least one UI element and the group of attributes and corresponding values for the at least one UI element; and
generating, by the one or more processing units, the descriptor file based on the identified group of attributes and the corresponding values for the at least one UI element.

4. The computer-implemented method of claim 1, further comprising:
updating, by the one or more processing units, the descriptor file by acquiring an attribute or a value manually input by a content provider.

5. The computer-implemented method of claim 1, wherein the generating, by the one or more processing units, the descriptor file for the UI based on the at least one of the design prototype and the front-end code of the UI includes retrieving information from a database, wherein the information includes an association of a UI element type to frequently used attributes of the UI element type.

6. The computer-implemented method of claim 1, wherein the transforming, by the one or more processing units, the descriptor file into the help content document for the UI using the trained NLG model comprises:
determining, by the one or more processing units, a language style to be used for help content of each UI element in the help content document of the UI; and
generating, by the one or more processing units, help content of each UI element from the descriptor file based on an algorithm, wherein the algorithm is generated by training an NLG model with help content training documents of a determined language style for each UI element type and with corresponding training descriptor files.

7. The computer-implemented method of claim 6, wherein the determined language style is selected from a plurality of language styles.

8. The computer-implemented method of claim 1, wherein the transforming the descriptor file into the help content document for the UI using the trained NLG model comprises:
determining, by the one or more processing units, a plurality of language styles to be used for help content of each UI element in the help content document of the UI; and
generating, by the one or more processing units, help content of each UI element from the descriptor file based on an algorithm selected from a plurality of algorithms, wherein each of the plurality of algorithms is corresponding to each of the plurality of language styles and is generated by training an NLG model with help content training documents of each of the plurality of language styles for each UI element type and with corresponding training descriptor files.

9. The computer-implemented method of claim 1, further comprising:
training, by the one or more processing units, an NLG model with help content training documents of a language style for each UI element type and with corresponding training descriptor files to generate an algorithm for generating help content of each UI element from the descriptor file;
wherein the training comprises:
annotating, by the one or more processing units, a help content training document to generate annotations indicating mappings between expressions in help content of each UI element in the help content training document and values in attribute-value pairs of the UI element in a corresponding training descriptor file;
updating, by the one or more processing units, the annotations by acquiring corrections to at least one of: the annotations in the help content training document, the expressions of the help content training document, and attribute-value pairs of a training descriptor manually input by a content provider; and
training, by the one or more processing units, the NLG model based on updated annotations in the help content training document and attribute-value pairs in the corresponding training descriptor file.

10. A computer system for user interface (UI) help content generation, comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
generating a descriptor file for a UI based on at least one of a design prototype and front-end code of the UI, wherein the descriptor file describes a group of attributes related to help content for at least one UI element of the UI and includes attribute-value pairs for the at least one UI element of the UI; and
transforming the descriptor file into a help content document for the UI using a trained natural language generation (NLG) model.

11. The computer system of claim 10, wherein the generating the descriptor file for the UI based on at least one of the design prototype and the front-end code of the UI comprises:
performing image recognition on the design prototype(s) to recognize the at least one UI element and identifying the group of attributes and corresponding values for the at least one UI element; and
generating the descriptor file based on the identified group of attributes and the corresponding values for the at least one UI element.

12. The computer system of claim 10, wherein the generating the descriptor file for the UI based on at least one of the design prototype and the front-end code of the UI comprises:
performing code parsing on the front-end code to identify the at least one UI element and the group of attributes and corresponding values for the at least one UI element; and
generating the descriptor file based on the identified group of attributes and the corresponding values for the at least one UI element.

13. The computer system of claim 10, further comprising:
updating the descriptor file by acquiring an attribute or a value manually input by a content provider.

14. The computer system of claim 10, wherein the generating the descriptor file for the UI based on the at least one of the design prototype and the front-end code of the UI includes retrieving information from a database, wherein the information includes an association of a UI element type to frequently used attributes of the UI element type.

15. The computer system of claim 10, wherein the transforming the descriptor file into the help content document for the UI using the NLG model comprises:
determining a language style to be used for help content of each UI element in the help content document of the UI; and
generating help content of each UI element from the descriptor file based on an algorithm, wherein the algorithm is generated by training an NLG model with help content training documents of a determined language style for each UI element type and with corresponding training descriptor files.

16. The computer system of claim 15, wherein the determined language style is selected from a plurality of language styles.

17. The computer system of claim 10, wherein the transforming the descriptor file into the help content document for the UI using the NLG model comprises:
determining a plurality of language styles to be used for help content of each UI element in the help content document of the UI; and
generating help content of each UI element from the descriptor file based on an algorithm selected from a plurality of algorithms, wherein each of the plurality of algorithms is corresponding to each of the plurality of language styles and is generated by training an NLG model with help content training documents of each of the plurality of language styles for each UI element type and with corresponding training descriptor files.

18. The computer system of claim 10, further comprising:
training an NLG model with help content training documents of a language style for each UI element type and with corresponding training descriptor files to generate an algorithm for generating help content of each UI element from the descriptor file,
wherein the training comprises:
annotating a help content training document to generate annotations indicating mappings between expressions in help content of each UI element in the help content training document and values in attribute-value pairs of the UI element in a corresponding training descriptor file;
updating the annotations by acquiring corrections to at least one of: the annotations in the help content training document, the expressions of the help content training document, and attribute-value pairs of a training descriptor manually input by a content provider; and
training the NLG model based on updated annotations in the help content training document and attribute-value pairs in the corresponding training descriptor file.

19. A computer program product for user interface (UI) help content generation, the computer program product comprising:
a non-transitory computer readable storage medium having program instructions embodied therewith, the program instructions executable by a processor to cause the processor to perform a method comprising:
generating a descriptor file for a UI based on at least one of a design prototype and front-end code of the UI, wherein the descriptor file describes a group of attributes related to help content for at least one UI element of the UI and includes attribute-value pairs for the at least one UI element of the UI; and
transforming the descriptor file into a help content document for the UI using a trained natural language generation (NLG) model.

20. The computer program product of claim 19, wherein the transforming the descriptor file into the help content document for the UI using the trained NLG model further comprises:
determining a language style to be used for help content of each UI element in the help content document of the UI; and
generating help content of each UI element from the descriptor file based on an algorithm, wherein the algorithm is generated by training an NLG model with help content training documents of the determined language style for each UI element type and with corresponding training descriptor files.
